(19) United States
(12) Patent Application Publication
(10) Pub. No.: US 2005/0092714 A1
(43) Pub. Date: May 5, 2005

(54) Electrical contact, method of manufacturing the same, electrode for vacuum interrupter, and vaccum circuit breaker

(75) Inventors: Shigeru Kikuchi, Hitachi (JP); Noboru baba, Hitachiota (JP); Akira Nishijima, Numazu (JP); Toshimasa Fukai, Suntou (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(73) Assignee: JAPAN AE POWER SYSTEMS CORPORATION, Tokyo (JP)

(21) Appl. No.: 10/921,863

(22) Filed: Aug. 20, 2004

(30) Foreign Application Priority Data
Oct. 31, 2003 (JP) 2003-371369

(51) Int. Cl. H01H 33/66

(52) U.S. Cl. 218/130

(57) ABSTRACT

The present invention relates to an sintered electric contact containing Cr in an amount of 15 to 30% by weight and Cu being balance as main components, 0.05 to 0.5% by weight of Te, 100 to 3000 ppm of O, 7.5 to 900 ppm of Al, and 15 to 750 ppm of Si.

### CLAIM OF PRIORITY

The present application claims priority from Japanese application serial No. 2003-371369, filed on Oct. 31, 2003, the content of which is hereby incorporated by reference into this application.

### TECHNICAL FIELD

The present invention relates to a new electrical contact, a method of manufacturing the contact, an electrode for a vacuum interrupter, and a vacuum circuit breaker.

### BACKGROUND OF THE INVENTION

As an electrode for a vacuum interrupter disposed in a vacuum circuit breaker, there is disclosed in Patent publication No. 1 and Patent Publication No. 2 a sintered Cr—Cu composite alloy that is manufactured by pressure-molding mixed powder of Cr as a refractory metal and Cu as a high electrical conductivity metal, followed by sintering the mixed powder at a temperature lower than a melting point of Cu. Further, in Patent Publication No. 3, there is disclosed an electrode material that is manufactured by pressure-molding a mixed powder of Cr powder as a refractory metal, Cu powder as a high conductivity metal and a low melting point metal such as Pb, Bi, Te and Sb, pre-sintering the molded powder at a temperature lower than the melting point of Cu, and impregnating the pre-sintered body with Cu. However, the publication does not disclose the concentrations of impurities.
(Patent Publication No. 1) Japanese Patent Laid-open 2002-245908
(Patent Publication No. 2) Japanese Patent Laid-open Hei 7-278703
(Patent Publication No. 3) Japanese Patent Laid-open Hei 9-274835

### DESCRIPTION OF THE INVENTION

Requirements for electrical electrodes of vacuum interrupters disposed in circuit breakers are interruption capability, voltage resistance property, welding resistance, etc. However, it is difficult to satisfy the requirements by the materials disclosed in the Patent Publications No. 1 and No. 2; thus, the materials are selected in accordance with usage and specifications such as capacitor.

In order to obtain electrode characteristics for use of the vacuum circuit breaker, a third element is added to the Cr—Cu composite metal; however, it is difficult to satisfy the interruption performance, voltage resistance and welding resistance, and control of the distribution of the additive element is difficult. As a result, considerable fluctuation of interruption performance is observed.

It is an object of the present invention to provide an electrical contact with excellent interruption performance, voltage resistance and welding resistance, a method of manufacturing the electrical contact, an electrode for a vacuum interrupter and a vacuum circuit breaker.

### BRIEF DESCRIPTION OF DRAWINGS

FIG. 1 is a cross sectional view of an electrode for a vacuum interrupter according to the present invention.

FIG. 2 is a cross sectional view of a vacuum interrupter according to the present invention.

FIG. 3 is a cross sectional view of a vacuum circuit breaker according to the present invention.

### SUMMARY OF THE INVENTION

The present invention is featured by an electrical contact made of a sintered alloy containing Cr in an amount of 15 to 30% by weight and Cu being balance as main components, 0.05 to 0.5% by weight of Te, 100 to 3000 ppm of O, 7.5 to 900 ppm of Al, and 15 to 750 ppm of Si.

The electrical contact of the present invention preferably contains 15 to 30% by weight of Cr and 70 to 84.5% by weight of Cu as main components. The electrical contact of the present invention should contain 1200 ppm or less of O, 400 ppm or less of Al, and 400 ppm or less of Si. More preferably, the electrical contact contains 1000 ppm or less of O, 300 ppm or less of Al, and 300 ppm or less of Si.

The electrical contact according to the present invention should preferably be a disc form having a center aperture formed in the center of the circle and a plurality of slit grooves penetrating the disc, wherein the disc having a flat form of a propeller is divided by the slit grooves. Further, the present invention relates to a method of manufacturing the electrical contact, which comprises pressure-molding mixed powder containing Cr and Cu as main components and 0.05 to 0.5% by weight of Te, and sintering the molding. The Cr powder preferably contains 2000 ppm or less of O, 3000 ppm or less of Al, and 2500 ppm or less of Si.

The powder should preferably contain 15 to 30% by weight of Cr, 70 to 84.5% by weight of Cu, and 0.05 to 0.5% by weight of Te, wherein a particle size of Cr—Cu alloy powder or Cr powder is 104 μm or less, and a particle size of Cu powder is 61 μm or less, and wherein the pressure for molding the mixed powder is 120 to 500 MPa and a sintering temperature is one lower than the melting point of Cu in an Ar atmosphere of 20 to 60 Pa.

Cr used in the present invention should contain O, Al and Si in amounts less than the specified amounts of oxygen, Al and Si; such the pure Cr material is prepared by the Thermit method, for example. As a result, it was discovered that the Cr material contained very small amounts of O, Al and Si; it has been discovered that the electrode for a vacuum interrupter satisfies desired interruption performance, voltage resistance and welding resistance and has little fluctuation of the properties by synergetic effect of Te in an amount of 0.05 to 0.5% by weight.

Oxygen contained in Cr in an amount of 50 to 3000 ppm is released at the time of interruption of current, which accelerates the travel speed of arc to make interruption easy. Since the electrode contains the above-mentioned amounts of Al and Si, gases such as oxygen, etc generated at the time of interruption adsorb, which keeps the electrode sound after the interruption.

The reasons of setting the preferred composition of the electrical contact are as follows. The electrical contact contains 15 to 30% by weight of Cr and Cu being balance, particularly 70 to 84.5% by weight of Cu; if the amount of Cr is less than 15% by weight, the interruption capacity and welding resistance become slightly lower, and if the amount of Cr is larger than 30% by weight, electrical conductivity becomes lower.

When the electrode contains O in the amount of 100 to 3000 ppm, Al in the amount of 7.5 to 900 ppm and Si in the amount of 15 to 750 ppm, the arc speed is accelerated by O released at the time of interruption, which makes interruption easy, and gases such as O are adsorbed by Al and Si after interruption, thereby to keep a desired interruption resistance. Accordingly, O, Al and Si act synergistically each other within the ranges set forth above, thereby to bring about excellent properties.

If the electrode contains 0.05 to 0.5% by weight of Te, welding between the electrodes is prevented. Te may be contained in at least one of the fixed electrode and the movable electrode so as to attain satisfactory welding resistance. If the amount of Te is smaller than 0.05% by weight, results are not satisfactory; if the amount of Te exceeds, Te may evaporate at the time of interruption thereby lowering the insulation resistance.

As mentioned above, the electrical contact is most preferably manufactured by sintering. In the method, the particle size of the alloy of Cr and Cu or Cr is 104 μm or less, and the particle size of Cu is 61 μm or less. When the powder having the particle sizes is used, an electrical contact having a structure where Cr and Cu are homogeneously dispersed is obtained so that fluctuation of properties is small.

In the sintering method of the present invention, the mixed powder is molded into a propeller shape having the center aperture in the center thereof, where the molded is divided by slits. The pressure of the molding is 120 to 500 MPa to obtain a density of 65 to 75%. If the pressure is less than that, the molding may crumble; if the density is more than that, the molding may tend to stick to the mold thereby to shorten the life of the mold and lower the productivity of the contacts.

The sintering atmosphere is preferably an Ar atmosphere of 20 to 60 Pa. The sintering temperature is lower than the melting point of Cu. when the sintering is carried out under the gaseous atmosphere pressure of 20 to 60 Pa, surface oxide film on Cu is removed and evaporation of Cu is prevented thereby to produce a dense electric contact. The sintering temperature is lower than the melting point of Cu, preferably 1050 to 1070° C., so that electrical contact with a precise contour is obtained to eliminate post-machining and to lower the production coat. The electrode for a vacuum interrupter comprises the above-mentioned disc as the electrical contact and an electrode rod connected to the disc.

The disc has the center aperture in the center the surface for arc generation, and the electrode rod is inserted into the aperture and fixed. The surface of the electrode rod at the arc generation side is preferably has a recess which is lower than the arc generation surface. If the strength of the disc is not enough, a reinforcing member is disposed between the disc member and the electrode rod. The electrode rod has a portion connected to the disc member that preferably has a diameter smaller than the portion connected to an outer conductor.

The vacuum interrupter according to the present invention comprises a pair of a fixed electrode and a movable electrode in a vacuum container, wherein at least one of the electrodes employs the above-mentioned electrical contact. Further, the vacuum circuit breaker according to the present invention comprises a the above-mentioned vacuum interrupter, conductor terminals each being connected to each of the fixed electrode and the movable electrode, and a operation means for operating the movable electrode.

According to the present invention, it is possible to provide the electrical contact with excellent properties of interruption performance, insulation resistance and welding resistance, a method of manufacturing the contact, a vacuum interrupter using the contact, and a vacuum circuit breaker.

Embodiments of the Present Invention:

In the following, the preferred embodiments for practicing the present invention will be explained by reference to examples; the present invention is not limited by these examples.

### EXAMPLE 1

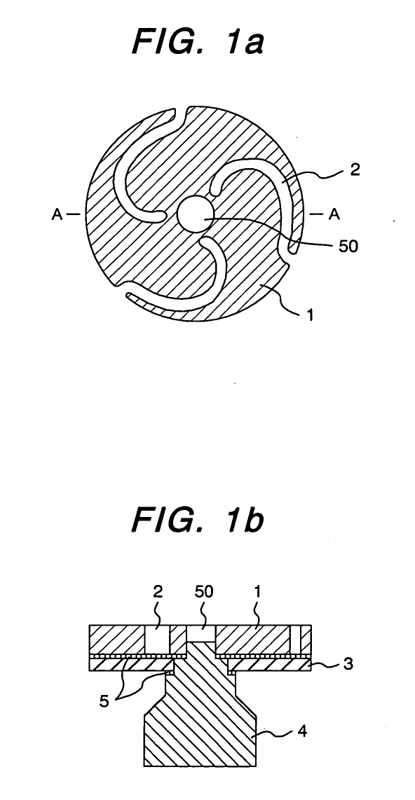

FIG. 1 shows a cross sectional view of an electrode for a vacuum interrupter of the present invention. (a) is a plan view of the electrical contact and (b) is a cross sectional view along the A-A line of (a). As shown in FIG. 1, the electrical contact 1 is made of a disc member of a propeller shape that has spiral grooves 2 for preventing stagnation of arc by giving driving force to the arc and a center aperture 50. The electrode for the vacuum interrupter comprises the electrical contact 1, a non-magnetic reinforcement member 3 made of stainless steel, the electrode rod 4, and a solder material 5. The reinforcement member 3 is disposed if necessary; if the strength of the electrical contact is enough, the reinforcement member can be omitted.

The method of manufacturing the electrical contact is as follows. Thermit Cr powder and electrolyzed chromium powder having a particle size of not larger than 63 μm and electrolyzed copper powder having a particle size of not larger than 60 μm were used. The Thermit Cr powder contained 680 ppm of O, 700 ppm of Al, and 800 ppm of Si. The electrolyzed Cr powder contained 4800 ppm of O, 26 ppm of Al, and 12 ppm of Si. As shown in Table 1, the electrical contact 1 has various compositions changing within a range of from 10 to 40% by weight of Cr and the balance being Cu. In addition, materials containing Te in amount of from 0.03 to 1.0% by weight were prepared. Amounts of O, Al and Si in the sintered alloys were determined.

At first, Cr powder and Cu powder were mixed to obtain predetermined compositions. Then, the mixed powder was filled in a mold for forming the electrical contact having the spiral grooves 2 and the center aperture 50. The powder was pressure-molded under a pressure of 400 MPa. The relative density of the resulting moldings was about 71%. The resulting moldings were sintered in argon atmosphere at 1050° C., which is lower than the melting point of Cu for 120 minutes to produce the electrical contacts.

The resulting contacts had a relative density of 94 to 97%. The method of manufacturing the electrode for the vacuum interrupter is as follows. The electrode rod was oxygen free copper, and the reinforcement member 3 was SUS304. The reinforcement member 3 was machined in advance into a desired shape. The project portion of the electrode rod 4 is inserted into the center aperture 50 of the sintered electrical contact and the center aperture of the reinforcement member 3 by means of the solder material 5. The solder material 5 was placed between the electrical contact 1 and the reinforcement member 3. The assembled was heated in 8.2×10-4 Pa at 970° C. for 10 minutes to produce the electrode shown in FIG. 1. The electrode had is an electrode for a vacuum interrupter of a rated voltage of 12 kV, rated current of 600 A, and rated interruption current of 25 kA. If the strength of the disc member is enough, the reinforcement member can be omitted.

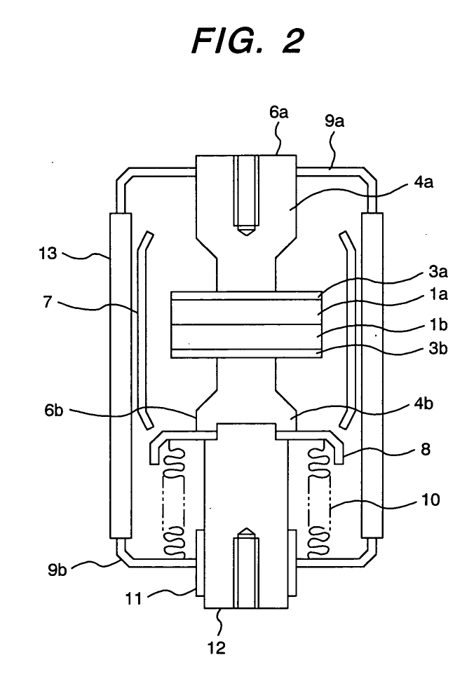

FIG. 2 shows a cross sectional view of a vacuum interrupter according to the present invention. In this example, the electrical contact for the vacuum interrupter was used to make a vacuum interrupter. The specifications of the vacuum interrupter were: a rated voltage of 12 kV, a rated current of 600 A, and a rated interruption current of 25 kA. As shown in FIG. 2, the electrode for the vacuum interrupter, which is prepared in Example 1 is constituted by an electrode contact 1a of the fixed electrode side, an electrode 1b of the movable electrode side, reinforcement members 3a, 3b, an electrode rod 4a of the fixed electrode side and an electrode rod 4b of the movable side. These members constitute the fixed electrode 6a, and the movable electrode 6b, respectively.

The movable electrode 6b is soldered to a movable electrode holder 12 by means of a movable side shield 8 for preventing scattering of metal vapor at the time of interruption. These members are hermetically soldered with a high vacuum by means of fixed electrode side plate 9a, movable electrode side plate 9b and an insulating cylinder 13. The screws of the fixed electrode 6a and the movable holder 12 are connected with outer conductors. There is the shield 7 for preventing scattering of metal vapor, etc at the time of interruption in the insulating cylinder 13. There is also a guide 11 for supporting a sliding portion between the movable electrode plate 9b and the movable electrode side holder 12.

There is disposed a bellows 10 between the movable side shield 8 and the movable side plate 9b, whereby the movable side holder 12 moves up and down, keeping the vacuum of the vacuum interrupter, thereby to make and break the contact between the fixed electrode 6a and the movable electrode 6b.

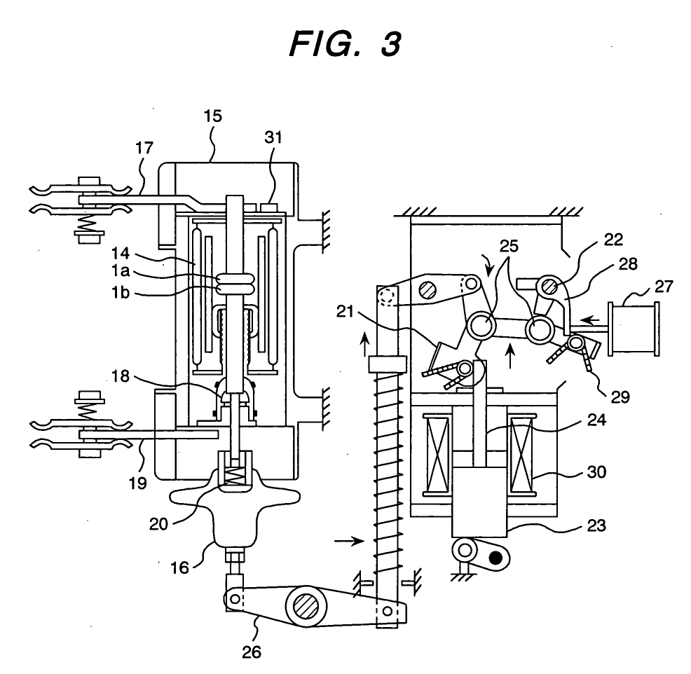

In this example, a vacuum circuit breaker was manufactured using the vacuum interrupter in Example 2. FIG. 3 shows a schematic view of the vacuum circuit breaker comprising the vacuum interrupter 14 and an operation mechanism.

The vacuum circuit breaker shows the operation mechanism located in front of the vacuum interrupter and three epoxy resin cylinders 15 for supporting the vacuum interrupter 14 of the three phase united type, which are located in the backside of the vacuum interrupter. The vacuum interrupter 14 is operated by means of an operating rod 16. When the vacuum interrupter is closed, current flows the upper terminal 17, electrical contacts 1a, 1b, collector 18 and the lower terminal 19. The contact force between the electrodes is kept by the contact spring 20 disposed to the operating rod. The electromagneto-motive force due to short-circuit current is supported by a supporting lever 21 and a prop 22.

When the vacuum interrupter is in the sate where the separation coil 27 is free, the separation coil is excited to unlock the prop 22 with the separation lever 28, thereby to rotate the main lever 26. As a result, the electrodes are separated.

When the vacuum circuit breaker is open state, the link returns by the action of the reset spring 29, after the electrodes are separated, and the prop 22 engages with the separation lever 28. When the closing coil 30 is excited in this state, the circuit is closed. The numeral 31 is an evacuation cylinder.

### EXAMPLE 2

In this example, interruption tests of the electrodes prepared in the example 1 for the vacuum interrupter were conducted to evaluate interruption performance. The interruption tests were carried out by installing the electrodes prepared in Example 2 to a vacuum interrupter of a rated voltage of 12 kV, a rated current of 600 A, and a rated interruption current of 25 kA, and assembled in the vacuum circuit breaker shown in Example 3. Table 1 shows the results of interruption tests. In Nos. 1 to 11, Thermit Cr powder was used, and in Nos. 12-13, electrolyzed Cr powder was used.

TABLE 1

| | Composition | | | Impurities | | | Performance | | |
|---|---|---|---|---|---|---|---|---|---|
| | % by weight | | | (ppm) | | | (relative value) | | |
| No. | Cr | Cu | Te | O | Al | Si | A | B | C |
| 1 | 15 | 85 | — | 557 | 98 | 134 | 1.05 | 0.90 | 0.95 |
| 2 | 20 | 80 | — | 702 | 149 | 142 | 1 | 1 | 1 |
| 3 | 20 | 79.95 | 0.05 | 748 | 151 | 136 | 1 | 0.97 | 1.10 |
| 4 | 20 | 79.5 | 0.5 | 869 | 131 | 177 | 1 | 0.95 | 1.40 |
| 5 | 25 | 75 | — | 755 | 168 | 179 | 0.97 | 1.10 | 1.05 |
| 6 | 30 | 70 | — | 837 | 220 | 225 | 0.95 | 1.18 | 1.12 |
| 7 | 10 | 90 | — | 4512 | 79 | 66 | 0.95 | 0.80 | 0.78 |
| 8 | 40 | 60 | — | 1002 | 308 | 343 | 0.90 | 1.25 | 1.15 |
| 9 | 20 | 79.97 | 0.03 | 719 | 137 | 129 | 1 | 0.97 | 1 |
| 10 | 20 | 79.3 | 0.03 | 907 | 153 | 184 | 0.95 | 0.85 | 1.55 |
| 11 | 20 | 79 | 0.7 | 1116 | 144 | 180 | 0.90 | 0.80 | 1.60 |
| 12 | 20 | 79.95 | 1.0 | 2237 | 11 | 53 | 0.77 | 0.80 | 1.35 |
| 13 | 20 | 80 | 0.05 | 2072 | 13 | 72 | 0.84 | 0.86 | 1.20 |

In Table 1, A stands for interruption current, B stands for insulation resistance and C stands for welding resistance. The interruption capacity is the maximum current value, which is being interrupted by the contacts. The insulation resistance is the maximum voltage at which the contacts separated by 6 mm do not discharge. The welding resistance is the maximum time for current of a rated value (25 kA) at which the closed contacts are separated without welding or sticking.

The properties are set forth in the relative values with respect to the values as 1 of the material No.2 (20% Cr-80% Cu). The electrical contacts No. 1 to 11 using Thermit Cr powder are explained in the following.

In 15% Cr—Cu (No.1), since an amount of Cr a refractory metal is only 15% by weight, interruption performance, insulation resistance and welding resistance may slightly lower; but the properties are satisfactory for the practical use. If 0.05 to 0.5% by weight of Te is added to 20% Cr—Cu (Nos. 3 and 4), the welding resistance increases, though the insulation resistance slightly decreases. The added Te prevents progress of sintering to lower the strength of the electrical contact, thereby to lower the separation force of the welded contacts. The lowering degree of insulation resistance has no problem from the practical point of view.

In 25Cr—Cu (No. 5), the insulation resistance increases as an amount of Cr increases, and distinguishing of arc was improved to slightly increase interruption performance. In 30Cr—Cu (No. 6), the conduction performance decreases and interruption performance slightly decreases; however, this degree has no problem from the practical point of view. Further, in 10Cr—Cu (No. 7), interruption performance slightly decreases, and arc tends to maintain as well as to lower the welding resistance, since an amount of Cr is small. In 40Cr—Cu (No. 8), sintering property is not good, since an amount of Cr is too large; since 0 is too much, interruption performance decreases.

In the present invention, Te was added to Cr—Cu alloys to increase high welding resistance. When an additive amount of Te is 0.03% by weight (No. 9), the improvement effect of welding resistance is slightly poor, compared with Cr—Cu (No. 3) containing 0.05% by weight of Te. On the other hand, if the amount of Te is larger than 0.5% by weight in 0.7% Cr—Cu (No. 10) and 1.0% by weight Cr—Cu (No. 11), insulation resistance and interruption performance decrease as an increase in amount of O and an amount of evaporation of Te increases. Accordingly, an amount of Te should be 0.05 to 0.5% by weight. In case of Nos. 12 and 13, wherein electrolyzed Cr powder was used, since an amount of O is too large, interruption performance and insulation resistance were 0.90 or less in the relative values, while the welding resistance is high. In case of Te addition, the interruption performance and the insulation resistance were further lower.

FIG. 4 shows relationship between amounts of Cr and interruption performance, insulation resistance and welding resistance. As shown in FIG. 4, the electrical contacts obtained by using Thermit Cr powder exhibited such high insulation resistance and welding resistance as 0.95 or more in the relative value, when an amount of 15% by weight of Cr. The interruption performance was 0.95 or more when an amount of Cr is 10 to 30% by weight. However, the electrical contact using electrolyzed Cr powder exhibited such low welding resistance and insulation resistance as 0.86 or less, while the interruption performance is 1.0 or more.

FIG. 5 shows relationship between amounts of Te and welding resistance. As shown in FIG. 5, electrical contacts using Thermit Cr powder and electrolyzed Cr powder showed such high welding resistance as 1.0 or more in relative value.

FIG. 6 shows relationship between amounts of Te and interruption performance and insulation resistance. The addition of Te until 0.5% by weight, as shown in FIG. 6, gives no influence on interruption performance at all, when Thermit Cr powder is used. When an additive amount is 0.7% by weight or more, the interruption performance became 0.95; the contact using electrolyzed Cr powder further decreased to 0.85 or less.

The electrical contact using Thermit Cr powder showed insulation resistance of 0.95 or more in the relative value until the amount of Te is 0.5% by weight. The electrical contact using electrolyzed Cr powder exhibited insulation resistance of 0.85 or less.

As having discussed above, the electrical contacts for vacuum interrupters containing specific amounts of O, Al and Si, and also containing 15 to 30% by weight of Cr and 0.05 to 0.5% by weight of Te excellent properties of interruption performance, insulation resistance and welding resistance. The electrical contacts can satisfy all of the properties. There is little fluctuation of interruption performance so that vacuum interrupters and vacuum circuit breakers with high performance, reliability and safety are realized.

In summary, the electrical contacts according to the present invention satisfy the following requirements: the interruption capacity (A) is the most important property for the vacuum interrupter and should be 1 or more of that of the comparative sample (No. 2), which consists of copper and chromium; the insulation resistance (B) should be at least 0.95 of that of the comparative sample No.1; and the welding resistance, which is the improving target of the present invention should be as high as possible. From this points of view, only the samples No. 3 and 4 can meet the criteria mentioned above.

1. An electric contact being composed of a sintered alloy containing 0.05 to 0.5% by weight of Te, 100 to 3000 ppm of O, 7.5 to 900 ppm of Al, and 15 to 750 ppm of Si, wherein the main components are Cr in an amount of 15 to 30% by weight and Cu being balance.

2. The electric contact according to claim 1, wherein an amount of Cu is 70 to 84.5% by weight.

3. The electric contact according to claim 1, wherein the amount of O is 400 to 1200 ppm, Al is 50 to 400 ppm, and Si is 50 to 400 ppm.

4. A method of manufacturing a electrical contact comprising pressing and molding mixed powder comprising 0.05 to 0.5% by weight of Te, and Cr in an amount of 15 to 30% by weight and Cu being balance as main components, and sintering the molded powder, wherein Cr powder contains 50 to 2000 ppm of O, 50 to 3000 ppm of Al and 100 to 2500 ppm of Si.

5. The method of manufacturing an electrical contact according to claim 4, wherein an amount of Cu is 70 to 84.5% by weight.

6. The method of manufacturing an electrical contact according to claim 4, wherein a particle size of an alloy of Cr and Cu or Cr is 104 μm or less, and a particle size of Cu is 61 μm or less.

7. The method of manufacturing an electrical contact according to claim 4, wherein the molding pressure is 120 to 500 MPa.

8. The method of manufacturing an electrical contact according to claim 7, wherein the sintering is carried out at a temperature not higher than a melting point of Cu in an Ar atmosphere of a pressure of 20 to 60 Pa.
